(19) United States
(12) Patent Application Publication
(10) Pub. No.: US 2009/0328234 A1
(43) Pub. Date: Dec. 31, 2009

(54) METHOD AND SYSTEM FOR PERFORMING INTEROPERABLE DIGITAL RIGHTS MANAGEMENT AMONG DIFFERENT OPERATING SYSTEM PLATFORMS

(75) Inventors: Chi-Yang CHOU, Kao-hsiung (TW); Pei-Yen CHOU, Hsin-chu (TW); Yeu-Chung LIN, Chang-hua (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: CONDEL INTERNATIONAL TECHNOLOGIES INC., George Town (KY)

(21) Appl. No.: 12/146,930

(22) Filed: Jun. 26, 2008

(51) Int. Cl. G06F 21/00

(52) U.S. Cl. 726/27

(57) ABSTRACT

A method for performing interoperable digital rights management among different operating system platforms is disclosed. Digital rights management programs are coded and compiled based on specific operating systems. Directories and auto-run folders relating to the directories for the compiled digital rights management programs are set up in a memory device of an electronic device. The compiled digital rights management programs are stored in the auto-run folders, respectively. When the memory device is inserted in the electronic device, an auto-run function of an operating system of the electronic device is automatically activated to select an auto-run folder, and one of the compiled digital rights management programs stored in the selected auto-run folder is accessed and executed.

### BACKGROUND OF THE INVENTION

1. Field of the Invention

The invention relates to digital rights management, and more particularly to a method for performing interoperable digital rights management among different operating system platforms by using auto-run functions of the operating systems. The interoperability of such DRM does not require altering or adding programs on electronic devices; it does not require changing the hardware structure or component of a commodity memory device either.

2. Description of the Related Art

In the past, program languages, such as the C++ language, have been used to code digital rights management programs. Digital rights management programs are used in electronic devices (such as mobile phones or computers), and are highly specific to the operating system of a particular electronic device. Digital rights management programs may operate within the bottom layer structure of an operating system of electronic devices, for accessing an operating system's sub-program. Digital rights management programs coded by program languages need to be converted to executable files for the operating system, using a compiler of the operating system.

A digital rights management program, for example, coded by the C++ language, is converted to “.sis” files using the compiler “makesis” of the operating system Symbian S60 V3. Thus, functions provided by the compiled digital rights management program can only be performed on the originally provided operating system platform. For example, the digital rights management program “FairPlay” compiled by the Mac operating system can only be applicable to Apple personal computers, i-Phone or i-Pod devices. Also, the digital rights management program “Windows Media DRM” compiled by the Windows operating system can only be applicable to devices which adopt Windows series platforms.

Thus, a method and system for performing interoperable digital rights management among different operating system platforms is desirable.

### BRIEF SUMMARY OF THE INVENTION

Methods for performing interoperable digital rights management among different operating system platforms are provided. An exemplary embodiment of a method for performing interoperable digital rights management among different operating system platforms comprises the following. Digital rights management programs are coded and compiled based on specific operating systems. Directories and auto-run folders relating to the directories for the compiled digital rights management programs are set up in a memory device, such as micro SD card. The compiled digital rights management programs are stored in the auto-run folders, respectively. When the memory device is inserted in the electronic device, the auto-run function of an operating system of the electronic device is automatically activated to select an auto-run folder, and one of the compiled digital rights management programs stored in the selected auto-run folder is accessed and executed.

Systems for performing interoperable digital rights management among different operating system platforms are provided. An exemplary embodiment of a system for performing interoperable digital rights management among different operating system platforms comprises a memory device and an electronic device. The memory device comprises a plurality of directories. Each directory comprises an auto-run folder storing an executable file and corresponding packaged files for digital rights management programs corresponding to specific operating systems. The electronic device is installed with an operating system providing an auto-run function. When the memory device is inserted in the electronic device, the operating system automatically activates the auto-run function to select an auto-run folder corresponding to the operating system and accesses and executes an executable file and corresponding packaged files stored in the selected auto-run folder.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a flowchart of a method for performing interoperable digital rights management among different operating system platforms of the present invention; and

FIG. 2 is a schematic view of a system for performing interoperable digital rights management among different operating system platforms of the present invention.

### DETAILED DESCRIPTION OF THE INVENTION

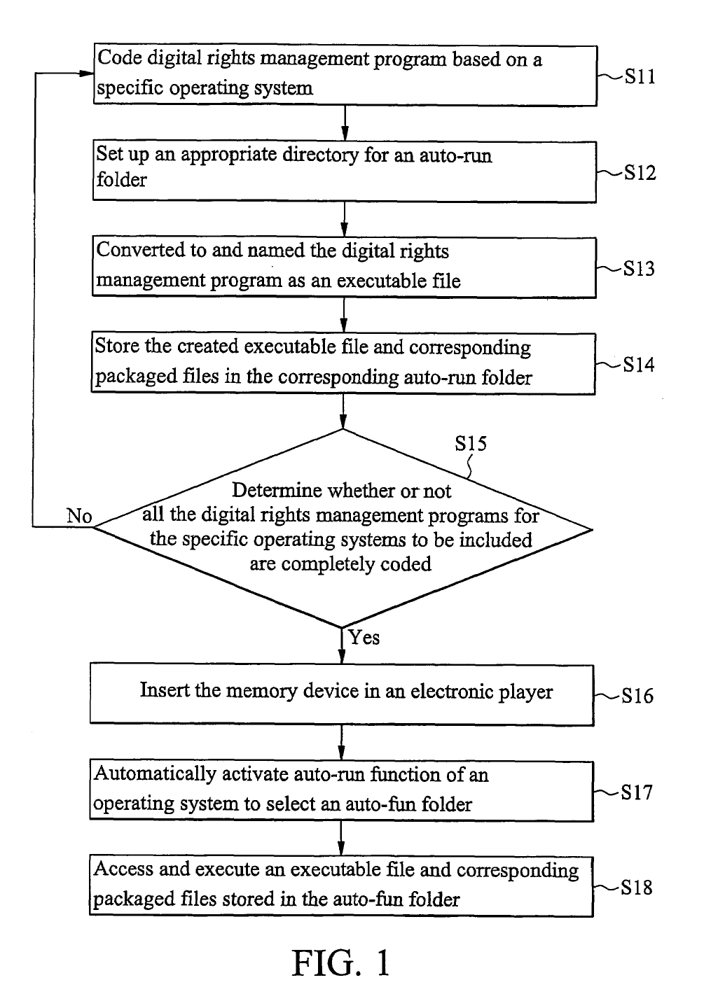

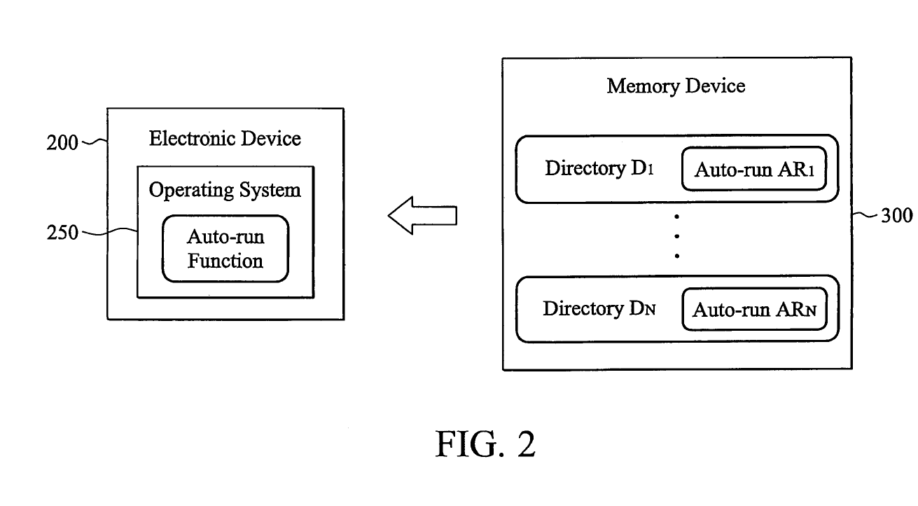

Several exemplary embodiments of the invention are described with reference to FIGS. 1 through 2, which generally relate to performing interoperable digital rights management among different operating system platforms. It is to be understood that the following disclosure provides various different embodiments as examples for implementing different features of the invention. Specific examples of components and arrangements are described in the following to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various described embodiments and/or configurations.

The invention discloses a method and system for performing interoperable digital rights management among different operating system platforms by using auto-run functions of operating systems.

A method of the invention, places sub-programs of the digital rights management program coded using program languages for various operating systems in designated directories of a memory device (a memory card, for example), based on file names assigned to corresponding auto-run functions. When the memory device is inserted in a specific electronic device, the operating system thereof searches specific files (i.e. digital rights management sub-programs) in a specific directory for automatically implementing the digital rights management. Thus, the digital rights management can be used in different operating system platforms to overcome interoperability problem.

Currently, an operating system of an electronic device generally provides auto-run functions for a portable flash memory device, enabling automatic detection and file search under a specific format in a specific directory when the flash memory device is inserted in the electronic device. If a corresponding auto-run file is located, the operating system of the electronic device automatically activates and performs the file. For example with the operating system “Symbian S60 V3”, the operating system provides a preinstalled application (PA) which is placed in a specific directory “\private\10202dce”, of which the file format of the auto-run file is represented by .sis and packaged files thereof are represented by “.pkg”. Additionally, for example with the operating system “Windows Mobile 5.0/6.0/6.1”, the operating system provides an auto-run file “autorun.exe” which is placed in a specific directory “\xxxx”, where the “xxxx” indicates a code of the micro-processor type of the electronic device. For instance, \2577 stands for the directory appropriate for electronic devices which adopt ARM (SA1100) for CPU. If the code of the micro-processor type of the electronic device cannot be realized in advance, the operating system will still search the auto-run file “autorun.exe” in the directory “\0” and automatically perform the auto-run file “autorun.exe”.

FIG. 1 is a flowchart of method for performing interoperable digital rights management among different operating system platforms of the present invention.

A digital rights management program for a memory device (memory card, for example) is coded based on a specific operating system (such as Symbian S60 V3 or Windows Mobile 5.0/6.0/6.1 or the like) to be included using program language (C++, for example) applicable for the specific operating system (step S11). An appropriate directory for an auto-run folder (\private\10202dce, for example) is set up on the memory device based on the specific operating system to store the digital rights management program (step S12).

The digital rights management program is then converted to and named as an executable file (.sis, for example). Additionally, corresponding packaged files (“.pkg”, for example) for the specific operating system use a compiler (makesis) corresponding to the specific operating system, wherein denomination and file format of the executable file corresponds to required specification for auto-run functions of the specific operating system (step S13). Thus, the coded digital rights management program can only be performed under the specific operating system (Symbian S60 V3 or Windows Mobile 5.0/6.0/6.1 or the like). The created executable files and corresponding packaged files for the corresponding digital rights management program are stored in the corresponding auto-run folder relating to the corresponding directory (step S14).

Next, it is determined whether or not all the digital rights management programs for the specific operating systems to be included are completely coded (step S15). If they are not completely coded, the process proceeds to step S21 to repeat the described process for coding another digital rights management program corresponding to another specific operating system until the other directories for auto-run folders are generated and corresponding executable files are created on the memory device for all the applicable operating systems to be included.

If they are completely coded, when the memory device is inserted in an electronic device (step S16), the auto-run functions of an operating system of the electronic device is automatically activated to select an auto-run folder corresponding to the operating system of the electronic device (step S17) and an executable file and corresponding packaged files stored in the selected auto-run folder for the digital rights management program corresponding to the operating system of the electronic device is accessed and executed (step S18).

FIG. 2 is a schematic view of a system for performing interoperable digital rights management among different operating system platforms of the present invention.

The system comprises an electronic device 200 (a personal computer or a mobile device, for example) and a memory device 300. The electronic device 200 is installed with an operating system 250 providing an auto-run function. The memory device 300 comprises a plurality of directories D₁.˜.D_{N}, wherein each directory comprises an auto-run folder (AR₁.˜.AR_{N}) storing an executable file (E₁.˜.E_{N}, for example, not shown) and corresponding packaged files (P_{1-1 . . . 1-M.}˜.E_{N-1 . . . EN-M}, for example, not shown) for digital rights management programs correspond to different operating systems. These packaged files can be of the same format if the targeted electronic devices adopt the same DRM engine, such as OMA DRM (Open Mobile Alliance DRM). They can be stored under other directories and be referred to when needed.

When the memory device 300 is inserted in the electronic device 200, the operating system 250 automatically activates the auto-run function to select an auto-run folder corresponding to the operating system 250 and accesses and executes an executable file (one of the auto-run folders AR₁.˜.AR_{N}) and corresponding packaged files stored in the selected auto-run folder.

The method for performing interoperable digital rights management can be implemented to different operating system platforms or electronic devices, such as Windows XP for a personal computers (PC)′ Windows Mobile 5.0/6.0/6.1 for mobile phones, or Windows CE for portable navigation devices (PND), thus, improving convenience of electronic devices.

Methods and systems of the present disclosure, or certain aspects or portions of embodiments thereof, may take the form of a program code (i.e., instructions) embodied in media, such as flash card or USB, or any other machine-readable storage medium, wherein, when the program code is loaded into and executed by a machine, such as a computer, the machine becomes an apparatus for practicing embodiments of the disclosure. The methods and apparatus of the present disclosure may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing and embodiment of the disclosure. When implemented on a general-purpose processor, the program code combines with the processor to provide a unique apparatus that operates analogously to specific logic circuits.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method of performing interoperable digital rights management program among different operating system platforms, comprising:
coding and compiling digital rights management programs based on specific operating systems;
setting up directories and auto-run folders relating thereto for the compiled digital rights management programs on a memory device of an electronic device;
storing the compiled digital rights management programs in the auto-run folders respectively;
when the memory device is inserted in the electronic device, automatically activating an auto-run function of an operating system of the electronic device to select an auto-run folder; and
accessing and executing one of the compiled digital rights management programs stored in the selected auto-run folder.

2. The method of performing interoperable digital rights management program among different operating system platforms as claimed in claim 1, further comprising: coding the digital rights management programs using program languages applicable for the specific operating systems.

3. The method of performing interoperable digital rights management program among different operating system platforms as claimed in claim 1, further comprising:
compiling the digital rights management programs to create executable files and corresponding packaged files for the specific operating systems using a compiler corresponding to the specific operating system.

4. The method of performing interoperable digital rights management program among different operating system platforms as claimed in claim 3, wherein the created executable file and corresponding packaged files are stored in their corresponding auto-run folders, respectively.

5. A system of performing interoperable digital rights management program among different operating system platforms, comprising:
a memory device, comprising plurality of directories, wherein each directory comprises an auto-run folder storing an executable file and corresponding packaged files for digital rights management programs corresponding to specific operating systems; and
an electronic device, installed with an operating system providing an auto-run function, wherein, when the memory device is inserted in the electronic device, the operating system automatically activates the auto-run function to select an auto-run folder corresponding to the operating system and accessing and executing an executable file and corresponding packaged files stored in the selected auto-run folder.

6. The system of performing interoperable digital rights management program among different operating system platforms as claimed in claim 5, wherein the digital rights management programs are coded and compiled based on the specific operating systems.

7. The system of performing interoperable digital rights management program among different operating system platforms as claimed in claim 5, wherein the digital rights management programs are coded using program languages applicable for the specific operating systems.

8. The system of performing interoperable digital rights management program among different operating system platforms as claimed in claim 5, wherein the digital rights management programs compiled to create the executable files and corresponding packaged files for the specific operating systems using a compiler corresponding to each specific operating system.

9. A computer-readable medium encoded with computer executable instructions for performing a method of performing interoperable digital rights management program among different operating system platforms, the computer executable instructions comprising:
when a memory device is inserted in an electronic device, automatically activating an auto-run function to select an auto-run folder corresponding to an operating system of the electronic device, wherein the memory device comprises plurality of directories, each directory comprises an auto-run folder storing an executable file and corresponding packaged files for digital rights management programs corresponding to specific operating systems; and
accessing and executing an executable file and corresponding packaged files stored in the selected auto-run folder.
